(19) United States
(12) Patent Application Publication
(10) Pub. No.: US 2021/0287060 A1
(43) Pub. Date: Sep. 16, 2021

(54) IMAGE FORMING APPARATUS

(71) Applicant: TOSHIBA TEC KABUSHIKI KAISHA, Tokyo (JP)

(72) Inventor: Toshiyuki UENO, Sunto Shizuoka (JP)

(21) Appl. No.: 17/166,774

(22) Filed: Feb. 3, 2021

(30) Foreign Application Priority Data
Mar. 12, 2020 (JP) 2020-043532

(51) Int. Cl. G06K 15/02; G06K 15/00; G06K 1/12; G06K 19/06

(52) U.S. Cl. CPC G06K 15/024; G06K 15/1848; G06K 15/1868; G06K 19/06037; G06K 15/407; G06K 1/121; G06K 15/1809

(57) ABSTRACT

An image forming apparatus includes an image forming unit and a control unit. The image forming unit is configured to print an image at an edge portion of a recording medium. The control unit is configured to generate a two-dimensional code image encoding information from a print job, divide the two-dimensional code image into a plurality of divided code images, and then control the image forming unit to print each divided code image at an end portion of a recording medium such that a two-dimensional code can be formed when a plurality of recording media are stacked after printing. The two-dimensional code encodes, for example, information related a document formed by the stacked the recording media.

### CROSS-REFERENCE TO RELATED APPLICATION

This application is based upon and claims the benefit of priority from Japanese Patent Application No. 2020-043532, filed on Mar. 12, 2020, the entire contents of which are incorporated herein by reference.

### FIELD

Example embodiments described herein relate generally to an image forming apparatus.

### BACKGROUND

In the related art, there is a technology capable of forming characters, text, marks, one-dimensional codes, or the like on the side surfaces of a stack or bundle of sheets forming a multipage document or the like. Such side surface marking on sheets can be utilized as a method for managing documents. However, such marking technology has a problem that the amount of information be provided may be relatively small.

### BRIEF DESCRIPTION OF THE DRAWINGS

FIG. 1 is a cross-sectional view of an image forming apparatus.

FIG. 2 is a schematic block diagram illustrating a hardware configuration of an image forming apparatus.

FIGS. 3A and 3B are diagrams illustrating an example of a two-dimensional code formed on a side surface of a document.

FIG. 4 is a diagram illustrating a display example of a screen for setting print conditions.

FIG. 5 is a diagram illustrating a display example of a screen for setting a formation area of the two-dimensional code.

FIG. 6 is a flowchart illustrating processing of a control unit in an image forming apparatus.

FIG. 7 is a diagram illustrating an example of a two-dimensional code formed at an end portion of a document when the number of pages constituting the document is small.

FIG. 8 is a diagram illustrating an example in which a two-dimensional code with a large width is formed at an end portion of some of the pages of a document.

FIGS. 9A and 9B are diagrams illustrating an example of a code formed on one of the pages constituting a document.

FIG. 10 is a flowchart illustrating the processing of a control unit when an image forming apparatus has a retrofit function.

FIG. 11 is a diagram illustrating a display example of a screen for setting print conditions when an image forming apparatus has a retrofit function.

### DETAILED DESCRIPTION

A problem to be solved by the certain embodiments is providing an image forming apparatus capable of printing codes or the like for facilitating document management.

According to one embodiment, an image forming apparatus includes an image forming unit and a control unit. The image forming unit is configured to print an image at an edge portion of a recording medium. The control unit is configured to generate a two-dimensional code image encoding information from a print job, divide the two-dimensional code image into a plurality of divided code images, and control the image forming unit to print each divided code image of the plurality of divided code images at an edge portion of a respective one of a recording medium in a plurality of recording media such that, when the plurality of recording media are stacked after printing, a two-dimensional code corresponding to the generated two-dimensional code image is formed.

Hereinafter, an embodiment for carrying out aspects of the present disclosure will be described. In the example embodiment description, the term “document” refers to a sheet bundle including at least two sheets on which characters or images are formed. That is, a document comprises multiple pages of images and/or text when printed.

Generally, when an image is formed on a sheet (or other recording medium), an image forming apparatus provides a non-image (margin) area at the outer edges of the sheet. The non-image area is generally an area on the sheet in which no image is formed so as to prevent the sheet from sticking to a transfer belt 72, a fixing device 75, or the like inside the image forming apparatus during the printing operation. The area of the sheet inside the non-image area may be referred to as the image area, the print region, the print field, or the like of the sheet . The non-image area is provided, for example, with a size of about 2 mm to 4 mm from a leading edge of the sheet in the conveyance direction . When printing on both sides of a sheet is to be performed, it is desirable to provide a similarly sized non-image area at both edges (leading and trailing) of the sheet in the conveyance direction since the front and rear directions of the sheet are switched to the upstream and downstream sides in the conveyance direction when the sheet is reversed for backside printing. The provision of the non-image area at each outer edge also allows the printed image to be fit on the sheet even when the sheet is shaken/moved/offset from its intended position during processing or if there is a phase difference or the like with respect to the travel of sheet and the image forming units or the like.

An image forming apparatus 1 of the present embodiment is capable of forming a two-dimensional code by forming images at/on the edge portions of a plurality of sheets, and then aligning and stacking these sheets. In this way, it becomes possible to add more information to the document than before. The two-dimensional code is a data representation code (encoding of data) having information in both the horizontal and vertical directions. The edge portions here are otherwise parts of non-image areas that further include side surfaces (edges) of the sheet. The area (“code area”) in which the two-dimensional code of the present embodiment is formed may, in some instances, extend into the image area as long as the code area also includes the edge portion of the sheet.

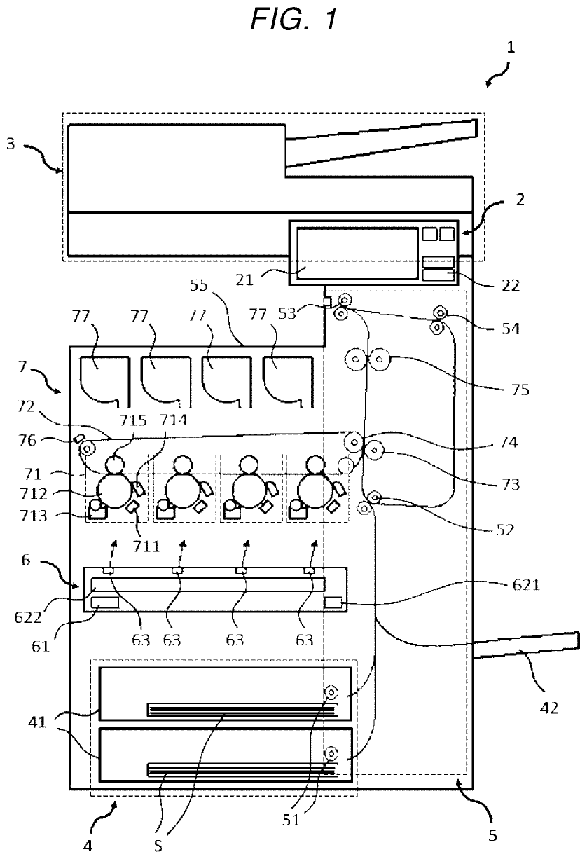

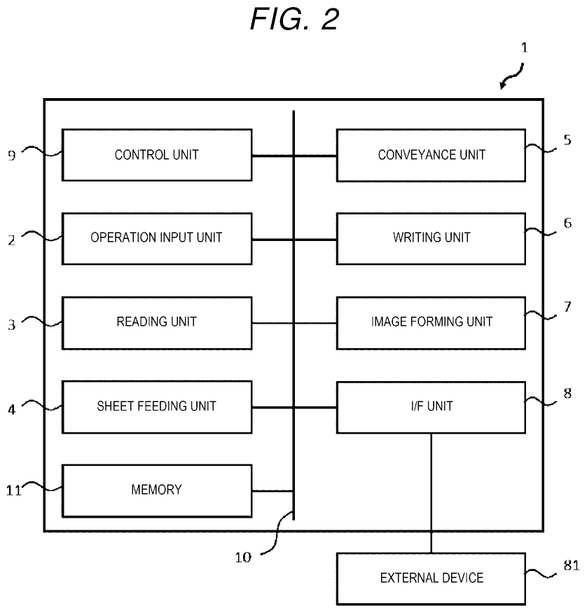

The configuration of the image forming apparatus 1 according to the present embodiment will be described with reference to FIGS. 1 and 2. FIG. 1 is a cross-sectional view of the image forming apparatus according to the present embodiment. The image forming apparatus 1 of the present embodiment will be described by taking a multifunction peripheral (MFP), as an example. In the present embodiment, a laser type printer is described as an example, but an ink jet type printer may be used instead. The image forming apparatus 1 has an operation input unit 2, a reading unit 3, a sheet feeding unit 4, a conveyance unit 5, a writing unit 6, and an image forming unit 7.

The operation input unit 2 has a display 21 and a physical key 22. The display 21 displays predetermined information. The physical key 22 (button or the like) receives an operation input by a user. The display 21 may be a touch panel display. The display 21 may thus receive an operation input based on the content displayed on the display 21 by a touching of the touch panel of the display 21. The operation input unit 2 and the display 21 are provided on the front side of the image forming apparatus 1, for example.

The reading unit 3 reads image information from a sheet based on signals of brightness and darkness of light returned from the sheet and records the image information in a memory 11. The reading unit 3 may be referred to as a document scanner or the like. The recorded image information may be transmitted to an external device 81 or may be subsequently printed (copied) as an image on another sheet by the image forming unit 7. The reading unit 3 may include an automatic document feeding (ADF) device and can be, for example, at an upper portion of the image forming apparatus 1. The automatic document feeding (ADF) device can convey a document (page by page) past a fixed scanner device or the like provided in the ADF device or the image forming apparatus 1 to read image information from the document (page by page).

The sheet feeding unit 4 has a sheet feeding cassette 41 and a manual sheet feeding tray 42. The sheet feeding cassette 41 is provided, for example, at a lower portion of the image forming apparatus 1. The sheet feeding cassette 41 accommodates sheets on which images can be subsequently formed/printed. A plurality of sheet feeding cassettes 41 may be provided. The size of the sheet accommodated in the sheet feeding cassette 41 can be set to any size in the image forming apparatus 1. The manual sheet feeding tray 42 can be used to feed a sheet of any size desired by the user. Via the manual sheet feeding tray 42, a sheet of a size that cannot be or is not accommodated in a sheet feeding cassette 41 can be fed for printing.

The conveyance unit 5 has a pickup roller 51, a registration roller 52, a paper discharge roller 53, a reversing roller 54, and other conveyance rollers. A line connecting each unit of the conveyance unit 5 and the sheet feeding unit 4 illustrated in FIG. 1 indicates a conveyance path of the sheets. A conveyance roller can be a roller disposed at a key place along the conveyance path and may serve as a relay between each unit during the conveyance of the sheet through the various portions of the image forming apparatus 1. The pickup roller 51 picks up a sheet from the sheet feeding unit 4 and sends out the sheet to the conveyance path. The registration roller 52 temporarily delays the conveying sheet and then sends out the sheet at a predetermined timing appropriate to receive an image. The paper discharge roller 53 sends out the conveyed sheet to the paper discharge tray 55. When performing the printing on both sides, the rotation direction of the paper discharge roller 53 can be reversed, and the sheet is sent to the reversing roller 54 from one end of the sheet on the upstream side in the conveyance direction. The reversing roller 54 sends the sheet to the registration roller 52 again. Thereafter, the sheet is discharged to the paper discharge tray 55 via the paper discharge roller 53.

The writing unit 6 has a laser emission unit 61, an optical element, and a slit glass 63. The writing unit 6 is provided, for example, at the lower portion of the image forming apparatus 1. The laser emission unit 61 outputs a laser beam based on the image information sent from an external device or the reading unit 3. The arrows point outward from the writing unit 6 in FIG. 1 indicates the irradiation direction of the laser beam. The optical element has a polygon mirror 621 and a lens 622. The optical element guides the laser beam output from the laser emission unit 61 to the slit glass 63. The slit glass 63 is provided at a position where a photoconductor 712 can be irradiated with the laser beam output from the laser emission unit 61. A plurality of slit glasses 63 may be provided corresponding to each station 71. The photoconductor 712 is irradiated with the laser beam output from the laser emission unit 61 via the optical element and the slit glass 63. The polygon mirror 621 is rotated by a polygon mirror motor, and the laser beam moves in the image main scanning direction of the photoconductor 712 by rotation of the polygon mirror 621. One main scanning is performed with respect to one surface of the mirror of the polygon mirror 621.

The image forming unit 7 includes a charging device 711, the photoconductor 712, a developing device 713, a photoconductor cleaner 714, a primary transfer roller 715, the transfer belt 72, a secondary transfer roller 73, a counter roller 74, the fixing device 75, a transfer belt cleaner 76, and a toner cartridge 77. The image forming unit 7 is provided above the writing unit 6, for example. Each toner cartridge 77 contains toner for forming an image on a sheet and replenishes the developing device 713 with the toner. The image forming apparatus 1 may have a plurality of toner cartridges 77. In the image forming apparatus 1 of the present embodiment illustrated in FIG. 1, the image forming apparatus 1 has one toner cartridge 77 for each of four colors, thus, from the left-hand side of the figure, a first toner cartridge 77 contains yellow toner, a second toner cartridge 77 contains magenta toner, a third toner cartridge 77 contains cyan toner, and a fourth toner cartridge 77 contains black toner. Although the colors of the toner used in the image forming apparatus 1 of the present embodiment is specifically described, the disclosure is not limited to any specific toner colors or arrangements of toner cartridges 77. A station 71 illustrated in FIG. 1 has a charging device 711, a photoconductor 712, a developing device 713, a photoconductor cleaner 714, and a primary transfer roller 715 as respective components. A plurality of stations 71 may be provided corresponding to the toner cartridges 77 included in the image forming apparatus 1. Furthermore, since the components provided in each station 71 illustrated in FIG. 1 have the same configuration, some of the reference numerals indicating these various components in different stations are omitted from the drawing. Charging device 711 electrostatically charges the surface of the photoconductor 712. Certain electric charges at positions on the surface of the photoconductor 712 are removed from the photoconductor 712 by the laser beam from the writing unit 6, by such a selective exposure of the photoconductor 712 to light from the writing unit 6, an electrostatic latent image is formed. The developing device 713 provides toner onto the photoconductor 712 to form a toner image corresponding to the previously formed electrostatic latent image. The primary transfer roller 715 then transfers the toner image from the photoconductor 712 to the transfer belt 72. The toner image transferred to the transfer belt 72 is conveyed to the secondary transfer roller 73. The photoconductor cleaner 714 removes the toner and the electric charges remaining on the photoconductor 712 after the primary transfer. The secondary transfer roller 73 and the counter roller 74 are rollers that face each other via the conveyance path of the sheet and operate to transfer the toner image from the transfer belt 72 to a sheet being conveyed from the sheet feeding unit 4. The transfer belt cleaner 76 removes the toner remaining on the transfer belt 72 after the secondary transfer. The fixing device 75 applies heat and pressure to melt (fuse) the toner image on the sheet and thus fix the toner image to the sheet.

The image forming apparatus 1 may have a two-dimensional code reader. The two-dimensional code reader can decode a two-dimensional code read by scanning the two-dimensional code with the light from a laser or an LED and convert (decode) the two-dimensional code that has been read into characters or numbers. The two-dimensional code reader may be configured to scan a two-dimensional code, for example. The two-dimensional code reader can also decode a one-dimensional code. The information decoded by the two-dimensional code reader may be displayed on the display 21 or the like.

FIG. 2 is a schematic block diagram illustrating a hardware configuration of the image forming apparatus 1 according to the present embodiment. The image forming apparatus 1 has an interface (I/F) unit 8, a control unit 9, and a memory 11 in addition to an operation input unit 2, a reading unit 3, a sheet feeding unit 4, a conveyance unit 5, and an image forming unit 7. Each of these functional units is connected via a bus 10 so that data communication is possible.

The I/F unit 8 is an interface for connecting the image forming apparatus 1 and an external device 81. The I/F unit 8 can be not only a wired interface but also a wireless interface. The external device 81 is, for example, a smart device, a personal computer (PC), an external memory, an external server, or the like. In this context, a smart device is a multi-function terminal that can provide functions such as communication a network, web browsing, or various applications. The external memory is, for example, a universal serial bus (USB) memory or a secure digital (SD) memory card, and is an external storage memory that is attachable and detachable from the image forming apparatus 1 separately from the built-in memory. The external server is, for example, a print server for connecting the image forming apparatus 1 to a computer network so that the image forming apparatus 1 can be used by a plurality of PCs.

The control unit 9 has a read only memory (ROM), a random access memory (RAM), and a central processing unit (CPU). The ROM stores a control program of the image forming apparatus 1. The RAM temporarily stores a data for executing the control program. The CPU is hardware that executes the instruction set of the control program. The control unit 9 controls each functional unit of the image forming apparatus 1 connected via the bus 10.

The memory 11 temporarily stores various data read from the control unit 9 or the external device 81. Programs and data are input to, and output from, the memory 11 by the control unit 9. The memory 11 is configured with a non-volatile memory. The memory 11 is, for example, an HDD or SSD. The memory 11 stores, for example, information related to the processing functions of the image forming apparatus 1. The memory 11 also stores print conditions, image data (document image data) to be printed in the image area, the number of sheets constituting a document, and a print job that is a set of files or the like concerning a printing operation.

The control unit 9 incorporates a printer driver. In this context, a printer driver is software that controls functions/operations of the image forming apparatus 1. The printer driver may be included in the external device 81. When a print condition is input, the printer driver creates a print job based on the information stored in the memory 11 or the connected external device 81. A printer driver included in the external device 81 can transmit an already created print job to the image forming apparatus 1 for printing. When the print job is transmitted from the external device 81, the image forming apparatus 1 receives the print job via the I/F unit 8 and stores the print job in the memory 11.

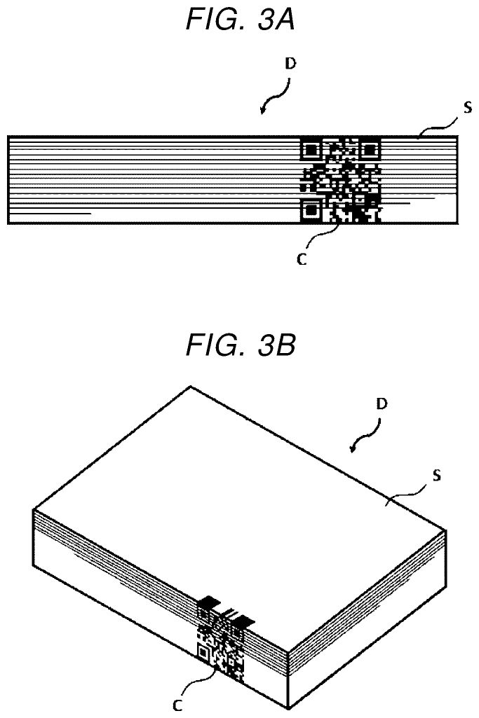

The two-dimensional code formed on the side surface of the document will be described with reference to FIGS. 3A and 3B. FIGS. 3A and 3B are diagrams illustrating an example of a two-dimensional code formed on the side surface of a document according to the present embodiment. FIG. 3A is a front view (edge on view) of the surface on which the two-dimensional code is formed. FIG. 3B is a perspective view of the document on which the two-dimensional code has been formed.

The two-dimensional code of the present embodiment is configured with image data in which information based on the additional information of the print job has been encoded by the control unit 9. As illustrated in FIG. 3A, the image forming apparatus 1 is capable of forming an image in the edge portion of the sheet so that a two-dimensional code C is formed on the side surface of the stacked pages of the document. As illustrated in FIG. 3B, the image(s) forming the two-dimension code (for example, rectangles in the edge portion of each sheet S) are formed by the image forming apparatus 1 so as to extend to very edge of the sheet S. The two-dimensional code is formed on the side surface of a document D when the printed sheets S of document D are stacked in a predetermined order.

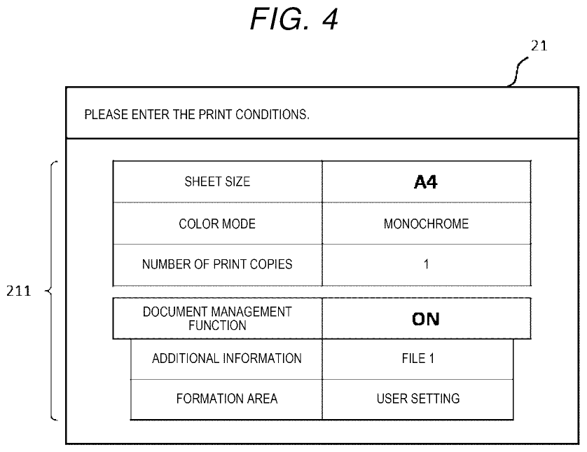

The print conditions will be described with reference to FIG. 4. FIG. 4 is a diagram illustrating a display example of a screen for setting print conditions according to the present embodiment. The print conditions are, for example, the size of the sheet, the color mode, the number of print copies, the necessity of the document management function, the additional information, and the formation area. As an input method for the print conditions, for example, the image forming apparatus 1 causes the display 21 to display a graphical user interface screen for setting the print conditions, as illustrated in FIG. 4. A user can input the print conditions into a print condition input unit 211 via the operation input unit 2.

As the sheet size, the size of the sheet used for printing such as A4 size or B5 size can be input, for example. As the color mode, it is possible to input the type of recording material to be used for forming the image, such as monochrome, color, or decolorable recording material. For the color mode, it may be possible to input so that different recording agents are used for the non-image area and the image area. As the number of print copies, the number of times the same data is printed in one print job can be input. For the document management function, it is possible to input ON or OFF to control the forming of the two-dimensional code on the document. As the additional information, the information to be included (encoded) in the two-dimensional code to be formed on the side surface of the document can be input via the document management function. The additional information may be related to the document such as a date, a file name, a file creator, a uniform resource locator (URL) . For the additional information, information stored in the memory 11 of the image forming apparatus 1 or the external device 81 can be selected. The formation area field permits adjustments in the position where the two-dimensional code will be formed on the document.

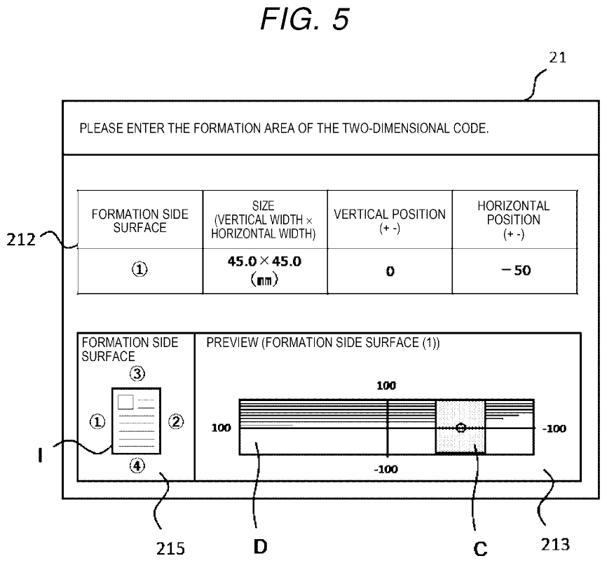

Aspects related to the formation area and the setting thereof will be described with reference to FIG. 5. FIG. 5 is a diagram illustrating a display example of a screen for setting the formation area for the two-dimensional code according to the present embodiment. The formation area is the area where the two-dimensional code will be formed on the document. The formation area setting information includes, for example, a formation side surface, a size, a vertical position, and a horizontal position of the two-dimensional code for the document. As an input method for settings for the formation area, the image forming apparatus 1 causes the display 21 to display a screen for setting the formation area for the two-dimensional code, as illustrated in FIG. 5, for example. The user can adjust the settings for formation area via a formation area input unit 212 and the operation input unit 2.

The selection of the surface to be used for forming the two-dimensional code on the document can be input to the formation side surface region. One of the values (1 to 4) illustrated in the formation side surface display 215 in FIG. 5 and assigned to the four sides of an icon I corresponding to a view of the document D viewed from above, can be input to the formation side surface region. The side surface of the document on which the two-dimensional code will be formed is the surface corresponding to the value input to the formation side surface region of the formation area input unit 212.

As the size, a value corresponding to the vertical dimension and the horizontal dimension of the two-dimensional code is input (for example, unit: mm). The maximum value for the value the vertical dimension of the two-dimensional code can be determined according to the number of sheets constituting the document being printed. For example, when the thickness of each sheet is 0.1 mm and the number of sheets constituting the document is 100, the maximum value of the vertical dimension for the two-dimensional code would be 10 mm. The control unit 9 acquires information regarding the number of sheets included in the area where the two-dimensional code is to be formed from the value of the vertical dimension, and stores the information in the memory 11. The thickness of each sheet is may vary depending on the type of sheet being used as well as sheet to sheet for sheets of the same nominal type. Therefore, the two-dimensional code may be formed by estimating the maximum value of the vertical dimension to be to be equivalent to somewhat less than the actual number of sheets being used for the document and/or by placing or leaving a space (margin) above and below the two-dimensional code to be formed in the vertical dimension. The maximum value for the horizontal dimension of the two-dimensional code can be determined according to the size of the sheets constituting the document. For example, when the size of a sheet constituting the document is A4 size (210×297 mm) and a surface forming the two-dimensional code is along the longitudinal width of the sheet, the maximum value of the horizontal dimension of the two-dimensional code is 297 mm. When a value close to a maximum value is input for the vertical dimension or the horizontal dimension, the image forming apparatus 1 may give a notification indicating that the two-dimensional code may extend beyond the side surface of the document.

For the vertical position and the horizontal position, values for adjusting a center position where the two-dimensional code is formed can be input in positions of the upper direction, lower direction, left direction, and right direction from the center point of the side surface where the two-dimensional code is formed. For the vertical position and the horizontal position, for example, in order to move the position to the upper direction and the left direction, a plus (+) number value is input and to move the position to the lower direction and the right direction, a minus (−) number value is input in the value where the maximum value is +100, the minimum value is −100, and the current point is 0.

As for the vertical position and the horizontal position, a position where the two-dimensional code is formed in the corresponding direction can be adjusted by inputting a predetermined value. The vertical position and the horizontal position may be displayed such that the relationship between the formation position and the value is visually shown, for example, as illustrated in a preview 213. A value using a unit of set length maybe input for the vertical position and the horizontal position (for example, when you input “−50 mm” in the “horizontal position”, the position where the two-dimensional code is formed moves 50 mm to the right direction).

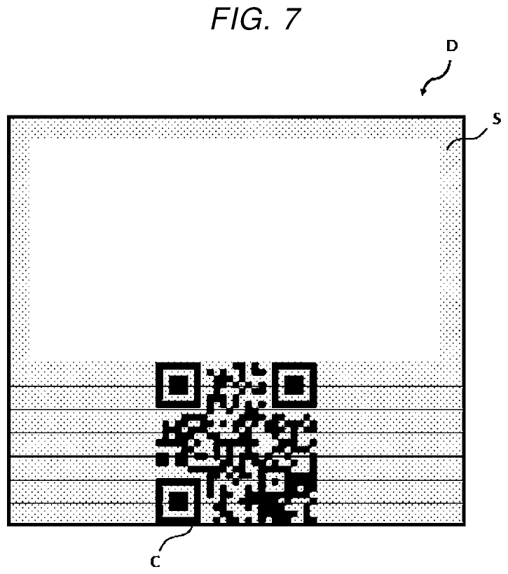

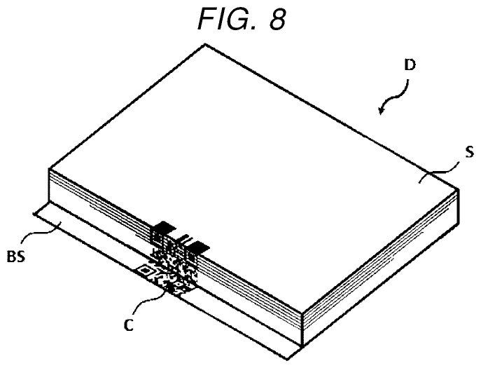

When the two-dimensional code cannot fit in the selected formation area based on the input value (s) , the user may be notified by display or sound that the position where the two-dimensional code is to be formed is not appropriate. Further, as illustrated in FIGS. 7 and 8, the two-dimensional code may be set so as to be printed on an end portion other than the side surface of the sheet.

In the formation area input unit 212, an initial, default value may be input for each item. When the formation area has default values, for example, the formation side surface is set to a side surface of the sheet of the image forming apparatus 1 parallel to the conveyance direction, the vertical dimension is set to the maximum value according to the number of sheets (in the document) being printed, the horizontal dimension is set to equal to the vertical dimension (i.e., a square formation area), and the vertical position and the horizontal position are set to a center of the surface on which the two-dimensional code is to be formed.

On the preview 213, a diagram based on the information input by the formation area input unit 212 is displayed. In the diagram displayed in the preview 213, the size or the thickness of the document D, and the size or the position of the two-dimensional code C change based on the information input by the formation area input unit 212 or the number of sheets constituting the document. When the formation area is being input, the formation area may be input by operating the two-dimensional code C displayed on the preview 213 by a touch operation (swipe, pinch-in or pinch-out, or the like) using a touch panel display 21.

Further, the image density or color of the two-dimensional code to be formed may be changeable according to user selection or the like.

Next, the image printed on the sheet constituting the document will be described. Synthesized image data obtained by synthesizing the document image data and the divided code image data is printed on the sheet constituting the document. The document image data indicates data of an image (document image) to be printed in the image area, which is generated based on the information of the print job. The divided code image data refers here to the data of an image (the divided code image) to be printed in the non-image area of the sheet. The divided code image data is obtained by dividing the image data for the two-dimensional code (code image data) that was generated based on the information input in the additional information of the print job. The divided code image data is obtained by dividing to code image data at a plurality of different points along the vertical direction into a plurality of different horizontal sections or slices. For example, when the document D illustrated in FIGS. 3A and 3B is created using the print conditions illustrated in FIG. 4 and the formation area illustrated in FIG. 5, the two-dimensional code C (illustrated in FIGS. 3A and 3B) encodes (stores) the information from the “file 1” of the additional information set via the screen illustrated in FIG. 4. Furthermore, the corresponding two-dimensional code C is formed in the formation area set via the screen illustrated in FIG. 5.

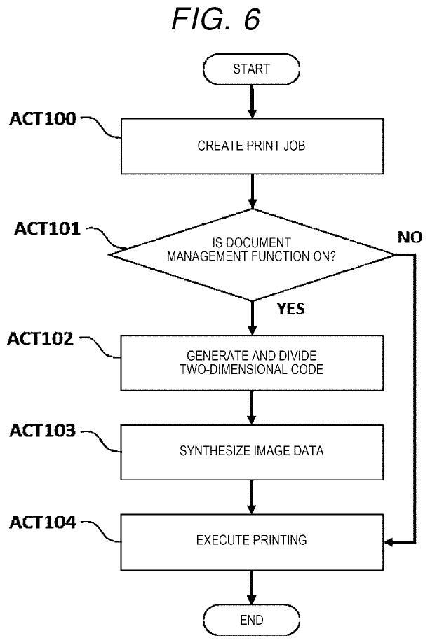

Next, an operation of the image forming apparatus 1 according to the present embodiment will be described. FIG. 6 is a flowchart illustrating processing of the control unit 9 in the image forming apparatus 1 according to the present embodiment. For the present embodiment, printing using a printer driver included in the image forming apparatus 1 will be described as an example.

First, the control unit 9 displays a screen for inputting the print conditions on the display 21. The user operates the operation input unit 2 to input the desired print conditions. In ACT 100, once the print conditions have been input, the printer driver creates a print job. The control unit 9 acquires information related to the print conditions, the information about the number of sheets, or the like from the created print job, and stores this acquired information in the memory 11.

In ACT 101, the control unit 9 determines whether or not the print job is to use the available document management function (s) based on the information acquired from the print job. When it is determined that the document management function is being used (YES in ACT 101), the process proceeds to generating code image data (ACT 102).

In ACT 102, the control unit 9 generates the code image data to be formed on the document and then generates divided code image data that is obtained by dividing the previously generated code image data. That is, the control unit 9 extracts the information to be added to the document from the additional information of the print job and generates image data of a two-dimensional code encoding the extracted information. Thereafter, the control unit 9 divides this generated code image data into a plurality of horizontal slices (divided code image data) based on the information about the number of sheets in the formation area for the two-dimensional code. The generated code image data and the divided code image data are stored in the memory 11.

In ACT 103, the control unit 9 synthesizes the document image data and the divided code image data so that a two-dimensional code will be formed at a predetermined position based on the indicated vertical position and horizontal position in the print job, and generates synthesized image data. Thereafter, the control unit 9 transmits the synthesized image data to the image forming unit 7.

In ACT 104, the image forming unit 7 prints the received synthesized image data on a sheet based on the print job. Further, when it is determined that the document management function is not to be used (NO in ACT 101), the control unit 9 simply transmits the document image data to the image forming unit 7 and controls the image forming unit 7 to print the document image data based on the print job (ACT 104).

The position of the two-dimensional code formed on the document is not limited as long as the two-dimensional code can be formed in an area including the edge portion of the document. However, in the image forming apparatus 1, if images are formed at the edge portions of the sheet on the upstream and downstream ends in the conveyance direction, it may cause the sheet to be caught (stuck or jammed). For example, when the image forming apparatus 1 using toner performs a copy or print operation and the toner adheres to the end portion of the sheet in the conveyance direction, the sheet may become caught in the transfer belt 72 or the fixing device 75 by not being peeled off after passing therethrough. Therefore, it is desirable to print the divided code image at the edge portion of the sheet so that the two-dimensional code formed on the side surface of the document is formed on a side surface of the sheet that is parallel to the conveyance direction. Such side surfaces may be referred to as lateral surfaces or lateral edges.

Next, an example of forming the two-dimensional code formed at an edge portion of the document will be described with reference to FIGS. 7 and 8. FIG. 7 is a diagram illustrating an example of a two-dimensional code formed at an edge portion of the document when the total number of sheets constituting the document is small. The dot pattern region on the sheets S depicted in FIG. 7 represents the location of the non-image area on the sheets S rather than any portion of the printed image(s). When the print conditions are set, it is conceivable that the requested two-dimensional code cannot be formed on the side surface of the document because the thickness of the document (that is, the number of sheets) with respect to the vertical dimension of the two-dimensional code is insufficient. Therefore, when the number of sheets constituting the document is equal to or smaller than the otherwise required amount, the two-dimensional code C may be formed using the non-image area as illustrated in FIG. 7. In this case, the code can be read by shifting (offsetting) the sheets S of the document at a predetermined interval. Furthermore, in such cases, an auxiliary line (helper line) indicating the appropriate predetermined interval for visualizing the two-dimensional code C may be printed on the sheets S together with the synthesized image so that the predetermined interval can be visually recognized to permit the sheets S to be appropriately arranged.

FIG. 8 is a diagram illustrating an example in which the two-dimensional code having an otherwise too large width is formed on the edge portion of some the sheets of the document according to the present embodiment. When the code image data is divided, the width of the images (horizontal slices) from which the two-dimensional code is formed may be set to have equal dimensions according to the total number of sheets constituting the document, or may be divided into horizontal slices of unequal widths. For example, the divided code image may be formed on any one or more of the sheets constituting the document to have a width larger than the other sheets by using more of the non-image area than used on the other sheets. As illustrated in FIG. 8, when the code is to be read, the two-dimensional code can be formed into a state for reading by shifting the sheet BS (on which the divided code image is printed with the large width) to a predetermined position to permit the full width of the printed portion of the two-dimensional code on the sheet BS to be seen/read. Thereby, even when the document is not thick enough (e.g., too few pages) to permit the two-dimensional code to be formed at an intended or necessary size on just the side surface of the document, a readable code can still be provided by shifting all the sheets S to an appropriate interval, as illustrated in FIG. 7, or by shifting less than all (e.g., just one) sheets S, for example, as for the document D illustrated in FIG. 8 for which the two-dimensional image is printed only on the sheet BS with an divided code image size different from those of the other sheets S is required to be offset from the other sheets S for reading the two-dimensional code. Therefore, the two-dimensional code can be formed by shifting only the sheet BS with a predetermined offset from the adjacent sheet S.

The number of two-dimensional codes formed on the document is not limited to just one. For example, two-dimensional codes can be formed on both side surfaces of the sheet parallel to the conveyance direction so that the supplied code may be read regardless of which side of the document is bound or the like, or in some instances different information may be stored in each of a plurality of two-dimensional codes on different sides of the document stack.

The example of forming the two-dimensional code described above may be selectable as a variation of an otherwise standard printing method when setting the print conditions.

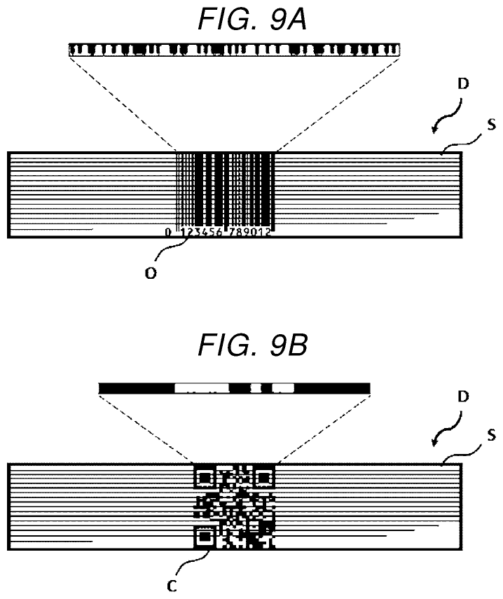

Features of the two-dimensional code compared with the one-dimensional code formed at the end portion of the sheet will be described with reference to FIGS. 9A and 9B. A feature of the two-dimensional code compared with the one-dimensional code is, for example, the amount of writable (encodable) information. A one-dimensional code has information provided only in the horizontal direction, while the two-dimensional code can have information in the vertical direction in addition to the horizontal direction. Therefore, the information density per area of the two-dimensional code is higher than that of the one-dimensional code.

Further, it is known that a two-dimensional code can incorporate an error correction function as a known technique. The error correction function in this context is a function that allows the code itself to permit restoration of data even when the printed code has blots, damage, or the like that might otherwise interfere with the successful reading of the coded information. The error correction function can be set in a manner to adjust the possible level of the data restoration, for example, the level of data restoration can be adjusted such that an error rate such as 7%, 15%, 25%, or 30% that can be restored.

FIGS. 9A and 9B are diagrams illustrating an example of a code formed on one of the sheets constituting the document. FIG. 9A is a diagram illustrating an example of a one-dimensional code. FIG. 9B is a diagram illustrating an example of a two-dimensional code. Since the one-dimensional code has information only in the horizontal direction, when the code is formed at the end portion of the document D as illustrated in FIG.9A, it is conceivable that, for the one-dimensional code, the content of the code could be inferred from just one sheet S of the document D. On the other hand, since the two-dimensional code illustrated in FIG. 9B has information in both the horizontal and vertical directions, the encoded content cannot be read from just one sheet S of the stack. For example, in some instances, when just a few of the printed sheets S of the document D are removed, the two-dimensional code be rendered unreadable. Furthermore, since the two-dimensional code is also capable of controlling the readability of the printed code depending on the level of the error correction function provided as described above, if the level of the error correction function is increased, it may still be possible to read the printed two-dimensional code on a document D with some of the sheets S removed or missing by use of the error correction function. When the sheets S constituting the document D are provided with page numbers, it can be possible to identify missing or removed pages by page number to supplement or resupply the missing pages/sheets.

The image forming apparatus 1 may utilize a decolorable recording material (e.g., decolorable toner). Decoloring in the present disclosure refers to making an image in a color initially different from the color of the background of the sheet become invisible to the unaided eye. The decolorable recording material is, for example, a recording material that becomes transparent when heated to a predetermined temperature, a recording material that becomes transparent when exposed to light of a particular wavelength, or a peelable recording material. As a result, a decolorable two-dimensional code can be formed at an edge portion of the document. After being decolored, two-dimensional code cannot be read by a standard two-dimensional code reader.

Further, the image forming apparatus 1 may be capable of printing the divided code image and the document image on the same sheet separately for the decolorable recording material and the non-decolorable recording material.

Since in this case only the two-dimensional code is decolorable, when there is a change in the additional information, such information can be updated simply by decoloring the old (un-updated) two-dimensional code and adding a new (updated) two-dimensional code with the correct additional information. As such, it is possible to prevent the encoded additional information before the change and the new encoded additional information from being mixed up with each other.

Information is stored in the one-dimensional code and the two-dimensional code by a pattern of light and darkness of a color. Therefore, depending on the color of the background of the sheet to be printed, it may not be easy to distinguish the brightness and darkness of a coded image, and thus it may be not easy to read the code or the code may not be readable at all. The image forming apparatus 1 of the present embodiment can be capable of printing the divided code image using two different types of recording materials (e.g., a bright color and a dark color) having a large difference (contrast) in brightness and darkness. For example, a black toner can be used for the dark color. For the bright color, any one of a yellow, magenta, cyan, or white toner can be used. In the recording agent for printing the divided code image, the dark color and the bright color are each represented by a single color. When the dark color and the bright color are represented with a mixture color using two or more kinds of recording agents, the contours may be blurred or the difference between the brightness and darkness may be reduced due to color shifting during printing so that the two-dimensional code formed on the document becomes difficult to read.

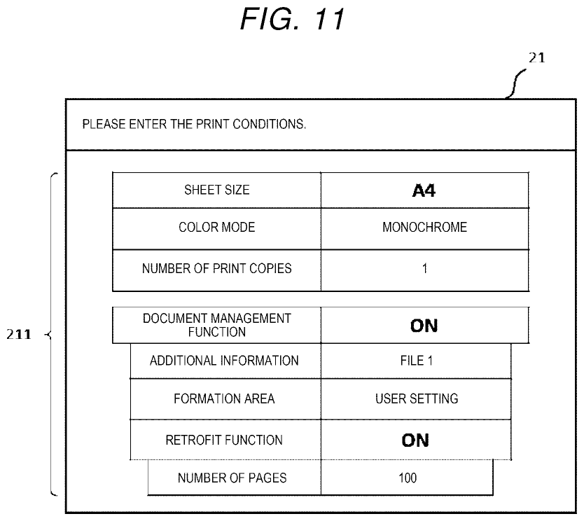

The image forming apparatus 1 may have a retrofit function for printing just the divided code images on sheets of a document . This makes it possible to add information on the edge portion of an existing (previously printed) document. The retrofit function can input whether to use the retrofit function, for example, when the print conditions are input. The retrofit function inputs a print condition “number of pages” as illustrated in FIG. 11. The number of pages is the number of sheets constituting an existing document . The control unit 9 can calculate the maximum number of divisions of the code image data, the maximum value of the vertical dimension of a two-dimensional code to be formed, the reference of the original point of the vertical position, and the like, according to the number of sheets constituting the document. When the two-dimensional code is formed a by the retrofit function, the document can be set in a sheet feeding cassette 41 or the manual sheet feeding tray 42.

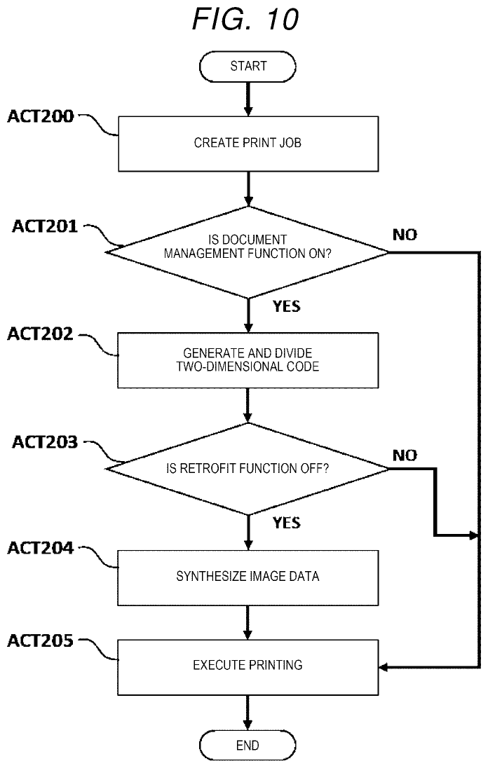

The operation when the retrofit function is used in the image forming apparatus 1 will be described. FIG. 10 is a flowchart illustrating the processing of the control unit 9 in the image forming apparatus 1 when a retrofit function according to the present embodiment is used. FIG. 11 is a diagram illustrating a display example of a screen for setting the print conditions of the image forming apparatus 1 having a retrofit function according to the present embodiment. The processing of the image forming apparatus 1 having a retrofit function will be described with reference to the flowchart in FIG. 10. ACT 200, ACT 201, ACT 202, and ACT 204 in FIG. 10 are substantially similar to processes as ACT 100, ACT 101, ACT 102, and ACT 103 in FIG. 7, respectively, as such differences between these processes in the present embodiment will be primarily highlighted in the following description.

First, the control unit 9 displays a screen for inputting the print conditions on the display 21. The user operates the operation input unit 2 to input the print conditions. In ACT 200, after the print condition is input, the printer driver creates a print job. The control unit 9 acquires information related to the print conditions, the information about the number of sheets, or the like from the created print job, and stores the information in the memory 11.

In ACT 201, the control unit 9 determines whether to use the document management function. When the document management function is to be used (YES in ACT 201), the processing of generating and dividing the two-dimensional code image is performed. When the document management function is not used (NO in ACT 201), the control unit 9 controls the image forming unit 7 to simply print the document image (ACT 205). In ACT 202, the control unit 9 generates and divides code image data from the print job to generate the divided code image data to be printed on each sheet.

In ACT 203, the control unit 9 determines whether or not the print job will use the retrofit function based on the information acquired from the print job. When it is determined that the retrofit function is to be used (NO in ACT 203) , the control unit 9 controls the image forming unit 7 to print only the divided code image (ACT 205) as opposed to the document image and the divided code image together.

On the other hand, when it is determined that the retrofit function is not used (YES in ACT 203), the control unit 9 synthesizes the divided code image data and the document image data (ACT 204) and then controls the image forming unit 7 to print the synthesized image data (ACT 205).

According to the embodiment described above, a two-dimensional code is formed at an edge portion of a sheet bundle (document) by printing an image at the edge portions of the sheets and then stacking the sheets to form the sheet bundle. This makes it possible to increase the amount of information that can be added to the edge portion of the document.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an image forming unit configured to print an image at an edge portion of a recording medium; and
a control unit configured to:
generate a two-dimensional code image encoding information from a print job,
divide the two-dimensional code image into a plurality of divided code images, and
control the image forming unit to print each divided code image of the plurality of divided code images at an edge portion of a respective one of a recording medium in a plurality of recording media such that, when the plurality of recording media are stacked after printing, a two-dimensional code corresponding to the generated two-dimensional code image is formed.

2. The image forming apparatus according to claim 1, wherein a vertical dimension of each divided code image is equal to each other divided code image in the plurality of divided code images.

3. The image forming apparatus according to claim 1, wherein a vertical dimension of the two-dimensional code image is set according to the number of recording media in the plurality of recording media.

4. The image forming apparatus according to claim 3, wherein each divided code image has dimensions equal to each other divided code image in the plurality of divided code images.

5. The image forming apparatus according to claim 1, wherein each divided code image has dimensions equal to each other divided code image in the plurality of divided code images.

6. The image forming apparatus according to claim 1, wherein at least one divided code image has a dimension that differs from the other divided code image in the plurality of divided code images.

7. The image forming apparatus according to claim 6, wherein the at least one divided image is printed on the first or the last recording medium in the plurality of recording media.

8. The image forming apparatus according to claim 1, wherein the control unit is configured to control the image forming unit to print the divided code image on the recording medium at the same time as document image information of the print job is printed on the recording medium.

9. The image forming apparatus according to claim 1, wherein the control unit is configured to control the image forming unit to print the divided code image on the recording medium on which document image information has already been printed.

10. The image forming apparatus according to claim 1, wherein, when the number of the recording media in the plurality of recording media is equal to or less than a predetermined number, the control unit is configured to control the image forming unit to print an auxiliary line indicating an offset stacking position on the recording media.

11. The image forming apparatus according to claim 1, further comprising:
a decolorable recording material for the image forming unit, wherein
the control unit is configured to control the image forming unit to print the divided code image using the decolorable recording material.

12. A printer control method for document management purposes, the method comprising:
generating a two-dimensional code image encoding information from a print job,
dividing the two-dimensional code image into a plurality of divided code images, and
controlling an image forming unit of a printer to print each divided code image of the plurality of divided code images at an edge portion of a respective one of a recording medium in a plurality of recording media such that, when the plurality of recording media are stacked after printing, a two-dimensional code corresponding to the generated two-dimensional code image is formed.

13. The method according to claim 12, wherein a vertical dimension of each divided code image is equal to each other divided code image in the plurality of divided code images.

14. The method according to claim 12, wherein each divided code image has dimensions equal to each other divided code image in the plurality of divided code images.

15. The method according to claim 12, wherein at least one divided code image has a dimension that differs from the other divided code image in the plurality of divided code images.

16. The method according to claim 15, wherein the at least one divided image is printed on the first or the last recording medium in the plurality of recording media.

17. The method according to claim 12, wherein the divided image code is printed on the recording medium at the same time as document image information of the print job is printed on the recording medium.

18. The method according to claim 12, wherein the divided code image is printed on the recording medium on which document image information has already been printed.

19. The method according to claim 12, wherein the divided code image is printed on the recording medium using a decolorable recording material.

20. The method according to claim 12, wherein the two-dimensional code encodes information related to the print job.
